(19) United States
(12) Patent Application Publication
(10) Pub. No.: US 2010/0232894 A1
(43) Pub. Date: Sep. 16, 2010

(54) Adaptor with Interchangeable Load Sensing Elements

(75) Inventors: Kurt A. Burton, Wildwood, MO (US); Michael P. Matlack, St. Charles, MO (US); Herbert L. Bommer, St. Peters, MO (US); John A. Baumann, St. Charles, MO (US)

Correspondence Address: DUKE W. YEE, YEE & ASSOCIATES, P.C., P.O. BOX 802333, DALLAS, TX, 75380, US

(73) Assignee: THE BOEING COMPANY, Chicago, IL (US)

(21) Appl. No.: 12/404,443

(22) Filed: Mar. 16, 2009

(51) Int. Cl. B23G 1/00; B23Q 3/155; H05B 1/00; B23B 35/00; B24B 1/00; B23P 11/00; B23B 3/00; B26D 3/00

(52) U.S. Cl. 408/9; 483/8; 219/52; 408/1 R; 451/28; 29/525.08; 82/1.11; 83/13

(57) ABSTRACT

An apparatus comprises a machine module and an instrument module. The machine module is capable of being connected to a power tool. The instrument module is capable of being connected to the machine module and capable of generating a number of signals containing information about a number of operating conditions during operation of the power tool.

### BACKGROUND INFORMATION

1. Field

The present disclosure relates generally to manufacturing and, in particular, to a method and apparatus for manufacturing objects. Still more particularly, the present disclosure relates to a method and apparatus for sensing process information during manufacturing of objects. Manufacturing involves the use of machines, tools, labor, and other suitable resources for producing objects.

2. Background

In manufacturing objects, power tools may be used to fabricate different types of components. Power tools may be used to perform a number of different types of operations. These operations include, for example, drilling, milling, cutting, grinding, riveting, and/or other suitable operations. Power tools also may be used to perform other operations, such as friction stir welding, sanding, and/or other suitable operations.

When using different types of tools, measuring the loads that are encountered during performing these operations may be useful. For example, in performing drilling, sensing a load along the axis of the drilling tool is often used to determine when the drill has exited a part or entered a different layer in a stack of layers forming the part. Further, other types of loads such as, for example, radial and torque loads also may be important.

With friction stir welding, loads such as axial loads, radial loads, and torque loads are monitored. The axial load is the load along an axis around which the friction stir welder rotates. A radial load is a load perpendicular to the direction of rotation. A torque load is the force needed to rotate an object about the axis.

In friction stir welding, control of the axial load is performed using a process parameter to control material temperature. Radial or side loads are used to control the linear welding speed. Torque load is an indication of material plasticity, while friction welding occurs.

The identification of these and other types of loads also may be used to determine when a tool may need maintenance, guide assembly of parts, control operations, determine when optimal operating conditions are reached, and/or identify other information used in performing these operations.

Some tools have components capable of measuring these loads built into the tool. For example, a drill may have one or more strain gauges associated with the spindle in the housing of the drill. With other tools, these types of capabilities may be added through an adapter.

For example, an adapter may have one end configured to be attached to a spindle of the power tool and a second end configured to be attached to a tool. The adapter contains components needed to measure various types of loads. For example, an adapter may contain strain gauges, accelerometers, and/or other suitable components for measuring loads during operation of a machine tool.

With currently available methods for measuring loads, serviceability of the tools is important. For example, when load-measuring elements are integrated as part of the tool, a failure of these components to provide desired measurements requires the tool to be serviced. As a result, the particular tool is unavailable for use. Also, the number of objects processed and/or speed at which objects are processed may be reduced if a replacement tool is not present.

With adapters, if a problem occurs with respect to the adapter, the power tool can still be used to perform operations. Measurement of loads, however, is unavailable until the adapter is repaired or another adapter is found to replace the faulty adapter.

Therefore, it would be advantageous to have a method and apparatus that takes into account one or more of the issues discussed above, as well as possibly other issues.

### SUMMARY

In one advantageous embodiment, a power tool system comprises a machine module, an instrument module, a tool module, a first plurality of fasteners, and a second plurality of fasteners. The machine module comprises a housing having a power tool interface capable of being connected to a power tool, a first instrument module interface capable of being connected to an instrument module, and a cooling system. The instrument module comprises a housing having a machine module interface, a tool module interface, and a number of sensors. The machine module interface is capable of being connected to the first instrument module interface on the machine module and a tool interface. The number of sensors is capable of measuring a number of operating conditions and generating a number of signals. The tool module comprises a housing having a second instrument module interface capable of being connected to the tool module interface on the instrument module and a tool interface. The tool interface is capable of receiving a tool. The first instrument module interface has a first number of slots and a first plurality of holes. The machine module interface has a first number of tabs capable of engaging the first number of slots and a second plurality of holes capable of being aligned with the first plurality of holes when the first number of slots is engaged with the first number of tabs to form first aligned holes. The tool interface has a second number of slots and a third plurality of holes. The second instrument module interface has a second number of tabs capable of engaging the second number of slots and a fourth plurality of holes capable of being aligned with the third plurality of holes when the second number of slots is engaged with the second number of tabs to form second aligned holes. The first plurality of fasteners is capable of being installed in the first aligned holes. The second plurality of fasteners is capable of being installed in the second aligned holes.

In another advantageous embodiment, an apparatus comprises a machine module and an instrument module. The machine module is capable of being connected to a power tool. The instrument module is capable of being connected to the machine module and capable of generating a number of signals containing information about a number of operating conditions during operation of the power tool.

In yet another advantageous embodiment, a method is present for operating a power tool. An adapter is attached to the power tool. The adapter comprises a machine module connected to the power tool, an instrument module connected to the machine module, and a tool module connected to the instrument module. The instrument module is capable of generating a number of signals containing information about a number of operating conditions during operation of the power tool. The tool module is capable of holding a tool. A number of operations are performed on a part with the adapter attached to the power tool.

The features, functions, and advantages can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the advantageous embodiments are set forth in the appended claims. The advantageous embodiments, however, as well as a preferred mode of use, further objectives and advantages thereof, will best be understood by reference to the following detailed description of an advantageous embodiment of the present disclosure when read in conjunction with the accompanying drawings, wherein:

FIG. 1 is a diagram illustrating an aircraft manufacturing and service method in accordance with an advantageous embodiment;

FIG. 2 is a diagram of an aircraft in which an advantageous embodiment may be implemented;

FIG. 3 is a diagram of a manufacturing environment in accordance with an advantageous embodiment;

FIG. 4 is a diagram illustrating an exploded view of an adapter in accordance with an advantageous embodiment;

FIG. 5 is an illustration of a side view of an adapter in accordance with an advantageous embodiment;

FIG. 6 is a diagram illustrating a cross-sectional view of an adapter in accordance with an advantageous embodiment;

FIG. 7 is a diagram of a view of one end of an adapter in accordance with an advantageous embodiment;

FIG. 8 is a diagram illustrating a cross-sectional view of an adapter in accordance with an advantageous embodiment;

FIG. 9 is a diagram illustrating a cross-sectional view of an adapter in accordance with an advantageous embodiment;

FIG. 10 is a diagram of a cross-sectional view of an adapter in accordance with an advantageous embodiment;

FIG. 11 is a cross-sectional view of an adapter in accordance with an advantageous embodiment;

FIG. 12 is a flowchart of a process for operating a power tool in accordance with an advantageous embodiment; and

FIG. 13 is a flowchart of a process for replacing a portion of an adapter in accordance with an advantageous embodiment.

### DETAILED DESCRIPTION

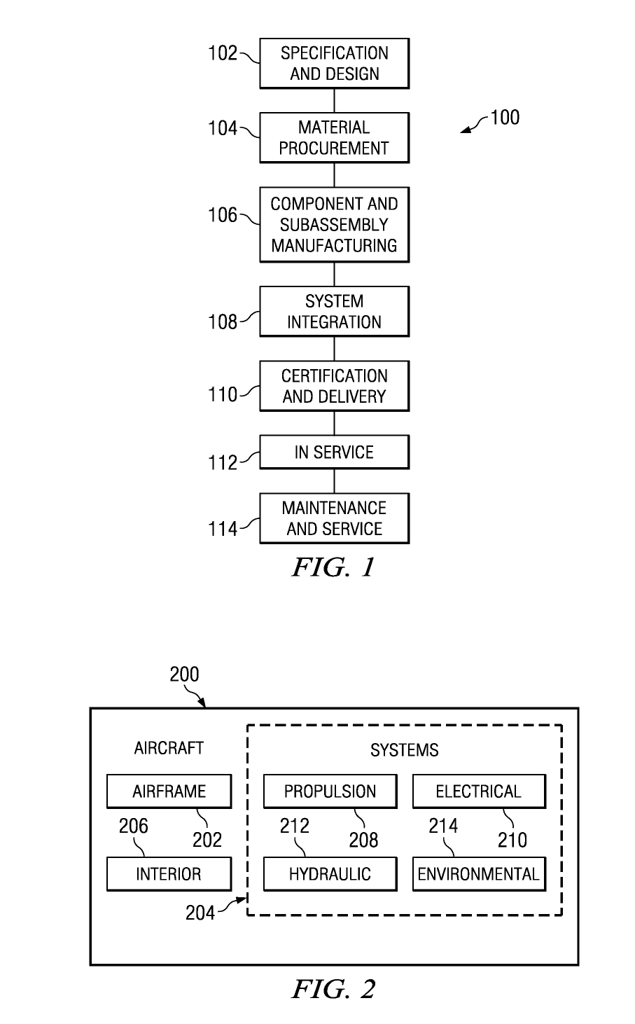

Referring more particularly to the drawings, embodiments of the disclosure may be described in the context of the aircraft manufacturing and service method 100 as shown in FIG. 1 and aircraft 200 as shown in FIG. 2. Turning first to FIG. 1, a diagram illustrating an aircraft manufacturing and service method is depicted in accordance with an advantageous embodiment. During pre-production, exemplary aircraft manufacturing and service method 100 may include specification and design 102 of aircraft 200 in FIG. 2 and material procurement 104.

During production, component and subassembly manufacturing 106 and system integration 108 of aircraft 200 in FIG. 2 takes place. Thereafter, aircraft 200 in FIG. 2 may go through certification and delivery 110 in order to be placed in service 112. While in service by a customer, aircraft 200 in FIG. 2 is scheduled for routine maintenance and service 114, which may include modification, reconfiguration, refurbishment, and other maintenance or service.

Each of the processes of aircraft manufacturing and service method 100 may be performed or carried out by a system integrator, a third party, and/or an operator. In these examples, the operator may be a customer. For the purposes of this description, a system integrator may include, without limitation, any number of aircraft manufacturers and major-system subcontractors; a third party may include, without limitation, any number of venders, subcontractors, and suppliers; and an operator may be an airline, leasing company, military entity, service organization, and so on.

With reference now to FIG. 2, a diagram of an aircraft is depicted in which an advantageous embodiment may be implemented. In this example, aircraft 200 is produced by aircraft manufacturing and service method 100 in FIG. 1 and may include airframe 202 with a plurality of systems 204 and interior 206. Examples of systems 204 include one or more of propulsion system 208, electrical system 210, hydraulic system 212, and environmental system 214. Any number of other systems may be included. Although an aerospace example is shown, different advantageous embodiments may be applied to other industries, such as the automotive industry.

Apparatus and methods embodied herein may be employed during any one or more of the stages of aircraft manufacturing and service method 100 in FIG. 1. For example, components or subassemblies produced in component and subassembly manufacturing 106 in FIG. 1 may be fabricated or manufactured in a manner similar to components or subassemblies produced while aircraft 200 is in service 112 in FIG. 1.

Also, one or more apparatus embodiments, method embodiments, or a combination thereof may be utilized during production stages, such as component and subassembly manufacturing 106 and system integration 108 in FIG. 1, for example, without limitation, by substantially expediting the assembly of or reducing the cost of aircraft 200. Similarly, one or more of apparatus embodiments, method embodiments, or a combination thereof may be utilized while aircraft 200 is in service 112 or during maintenance and service 114 in FIG. 1. In one illustrative example, one or more of the different advantageous embodiments may be employed to manufacture parts for aircraft 200 during component and subassembly manufacturing 106 and/or during maintenance and service 114.

The different advantageous embodiments take into account and recognize a number of different considerations. For example, the different advantageous embodiments recognize and take into account that the currently used adapters are one-piece adapters capable of being replaced if the measurement components within the adapter lose some functionality, fail to provide load information, and/or provide inaccurate information. The adapter can also be replaced if some other undesirable condition occurs.

With some types of power tools, heat is a factor during operation. Coolant is typically circulated through a portion of the adapter and the spindle in the friction stir welding tool. When removing the adapter for servicing and/or replacement, coolant is typically lost. The coolant is cleaned up and replaced. This process increases the expense, time, and labor needed to manufacture objects when an adapter is removed from the friction stir welding tool.

The different advantageous embodiments also recognize that other conditions may result in a need to service the tool. For example, if a tool is misaligned when mounting the tool onto the adapter, threads may be stripped in the adapter, requiring replacement of the adapter.

The different advantageous embodiments also recognize and take into account that although an adapter may be replaced, the availability of adapters from a supplier may prevent monitoring loads for the tool until a replacement adapter can be obtained. Further, currently available adapters have signal wires that extend from the adapter, which may fail and/or break after limited handling.

Additionally, when removing an adapter, leakage of coolant occurs from the spindle. This spillage may be from around three gallons to around five gallons upon removing an adapter from a friction stir welder. Sealing the adapter to the spindle uses O-ring seals. O-rings fit into the adapter. When reinstalling an adapter, the O-rings may not properly fit to provide a desired seal for the coolant. As a result, the O-rings must be reinstalled if a desired seal does not occur.

Thus, in view of recognizing and taking into account the considerations discussed above, the different advantageous embodiments provide a method and apparatus for providing sensing elements in an adapter for use in manufacturing parts and/or operating a power tool. In the different advantageous embodiments, an adapter comprises a machine module, an instrument module, and a tool module. The machine module is capable of being connected to a power tool. The instrument module is capable of being connected to the machine module and is capable of generating a number of signals containing information about operating conditions during operation of the power tool. The tool module is capable of being connected to the instrument module and capable of holding a tool.

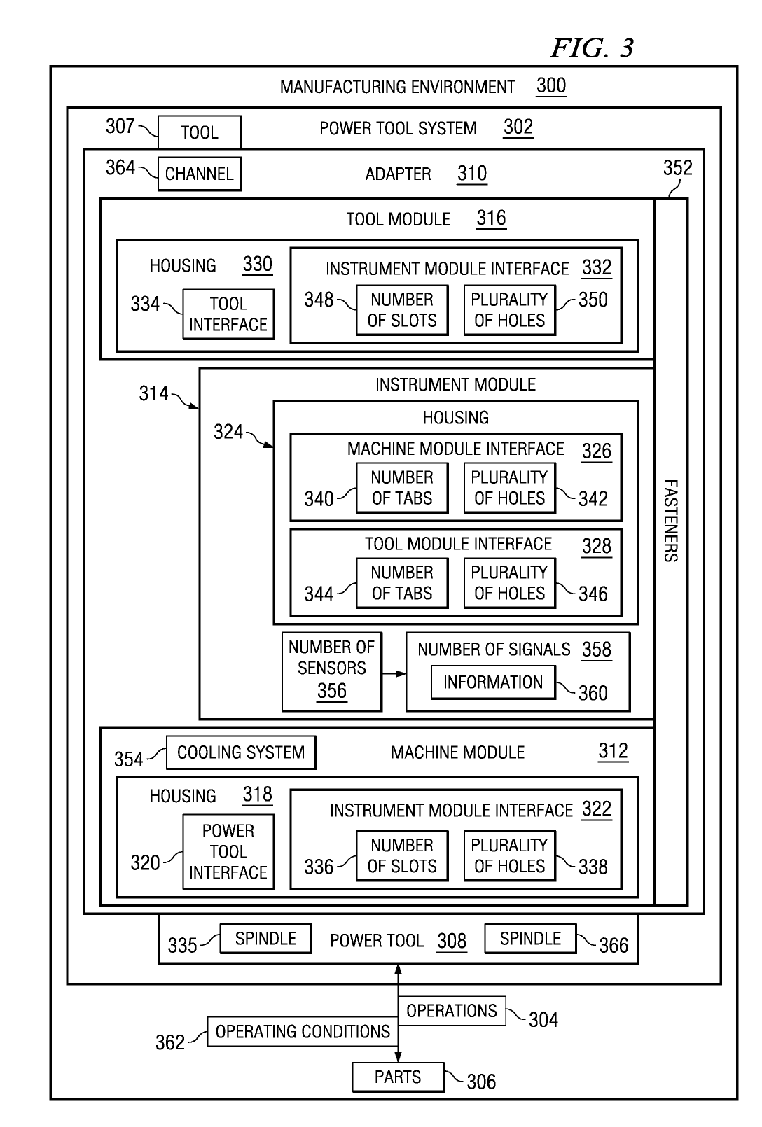

Turning now to FIG. 3, a diagram of a manufacturing environment is depicted in accordance with an advantageous embodiment. In this illustrative example, manufacturing environment 300 includes power tool system 302, which may perform operations 304 on parts 306. These operations may include, for example, without limitation, drilling operations, milling operations, friction stir welding operations, grinding operations, sanding operations, cutting operations, riveting operations, and/or other suitable operations.

In these illustrative examples, tool 307 is connected to power tool 308 using adapter 310. Power tool 308 may take various forms, depending on the particular implementation. For example, without limitation, power tool 308 may be a drill, a lathe, a milling machine, a riveting machine, a friction stir welding machine, a grinder, a cutting machine, or some other suitable power tool. Power tool 308 is a tool that may be powered by a power source such as, for example, without limitation, an electric motor, a compressed air motor, a gasoline engine, and/or some other source of power.

In these illustrative examples, adapter 310 comprises machine module 312, instrument module 314, and tool module 316. Each of these modules may be removably attached to each other to form adapter 310.

Machine module 312 is configured to be connected to power tool 308. Instrument module 314 is configured to be connected to machine module 312. Tool module 316 is configured to be connected to instrument module 314.

In these illustrative examples, machine module 312 comprises housing 318, which has power tool interface 320 and instrument module interface 322. Instrument module 314 comprises housing 324, which has machine module interface 326 and tool module interface 328. Tool module 316 comprises housing 330, which has instrument module interface 332 and tool interface 334.

In these illustrative examples, housing 318, housing 324, and housing 330 are comprised of a material that is capable of or configured to allow adapter 310 to be used during various operations performed with power tool 308. For example, without limitation, these housings may be comprised of a material selected from one of steel, titanium, aluminum, a metal alloy, and/or some other suitable material.

Power tool interface 320 for machine module 312 is configured to be connected to power tool 308. In these illustrative examples, power tool interface 320 of machine module 312 is connected to spindle 335 on power tool 308. Instrument module interface 322 is configured to be connected to machine module interface 326. Tool module interface 328 is configured to be connected to instrument module interface 332 in these examples. Additionally, tool interface 334 is configured to connect to tool 307.

Of course, in some advantageous embodiments, instrument module 314 and tool module 316 may have their functions combined. For example, without limitation, instrument module 314 may include tool interface 334, which is configured to connect to tool 307. As a result, adapter 310, in this particular advantageous embodiment, has two modules instead of three modules.

In these illustrative examples, instrument module interface 322 for machine module 312 has number of slots 336 and plurality of holes 338. As used herein, a number referring to an item refers to one or more items. For example, a number of slots is one or more slots.

Machine module interface 326 has number of tabs 340 and plurality of holes 342. Tool module interface 328 has number of tabs 344 and plurality of holes 346. Instrument module interface 332 has number of slots 348 and plurality of holes 350.

Number of tabs 340 is capable of engaging number of slots 336. Further, number of tabs 344 is capable of engaging number of slots 348.

Additionally, plurality of holes 338 in instrument module interface 322 is configured to be aligned with plurality of holes 342 in machine module interface 326 when number of tabs 340 in machine module interface 326 is engaged with number of slots 336 in instrument module interface 322. Plurality of holes 346 in tool module interface 328 is configured to be aligned with plurality of holes 350 in instrument module interface 332 when number of tabs 344 in tool module interface 328 is engaged with number of slots 348 in instrument module interface 332.

When the different pluralities of holes are aligned, fasteners 352 may be installed in the aligned holes to connect the different modules to each other. The use of fasteners 352 along with the tabs being engaged with the slots provides a mechanism to connect the different modules to each other. Further, the tabs and slots also may aid in reducing torque that may be applied to adapter 310. The tabs and slots may reduce and/or prevent movement of these modules relative to each other during different operations that may be performed.

In this illustrative example, machine module 312 includes cooling system 354. Cooling system 354 may allow coolant to flow through machine module 312 in a manner that reduces heat that may be generated during the performance of operations 304.

Additionally, instrument module 314 comprises number of sensors 356. Number of sensors 356 is configured to detect and/or sense operating conditions 362 that occur during operation of power tool 308. Number of sensors 356 is configured to generate number of signals 358 containing information 360 about operating conditions 362 that occur during the operation of power tool 308. In these illustrative examples, the operating conditions may include at least one of a load, an axial load, a radial load, torque, temperature, revolutions per minute, and/or some other suitable type of operating condition.

As used herein, the phrase “at least one of”, when used with a list of items, means that different combinations of one or more of the listed items may be used and only one of each item in the list may be needed. For example, “at least one of item A, item B, and item C” may include, for example, without limitation, item A or item A and item B. This example also may include item A, item B, and item C or item B and item C.

Number of sensors 356 may take various forms. For example, number of sensors 356 comprises at least one of an accelerometer, a strain gauge, a piezoelectric sensor, a wheatstone bridge, a temperature sensor, a position sensor, and/or some other suitable type of sensor.

With adapter 310, serviceability of power tool system 302 increases as compared to currently used adapters. If a failure occurs in the interface between tool module 316 and tool 307, tool module 316 may be removed without removing other parts of adapter 310.

This type of configuration is useful when cooling system 354 is present in adapter 310. As a result, removal of tool module 316 does not require removal of machine module 312. As a result, loss of coolant and resealing of adapter 310 to power tool 308 may be avoided. Further, if instrument module 314 becomes faulty or a new instrument module becomes available, instrument module 314 may be removed or detached from machine module 312 and a replacement instrument module may be attached to machine module 312. As a result, machine module 312 does not need to be removed. This situation avoids a loss of coolant. As a result, the amount of labor and cost for performing maintenance on power tool system 302 may be reduced.

The illustration of power tool system 302 in manufacturing environment 300 in FIG. 3 is not meant to imply physical or architectural limitations to the manner in which different advantageous embodiments may be implemented. Other components in addition and/or in place of the ones illustrated may be used. Some components may be unnecessary in some advantageous embodiments. Also, the blocks are presented to illustrate some functional components. One or more of these blocks may be combined and/or divided into different blocks when implemented in different advantageous embodiments.

For example, in some advantageous embodiments, adapter 310 may include channel 364, which may receive spindle 366, which is concentric with spindle 335. In other words, spindle 366 may rotate around the same axis as spindle 335. In some advantageous embodiments, fasteners 352 may be unnecessary to connect the different components of adapter 310 to each other. Instead, a locking mechanism may be used to hold the tabs within slots and/or connect the different modules to each other for adapter 310.

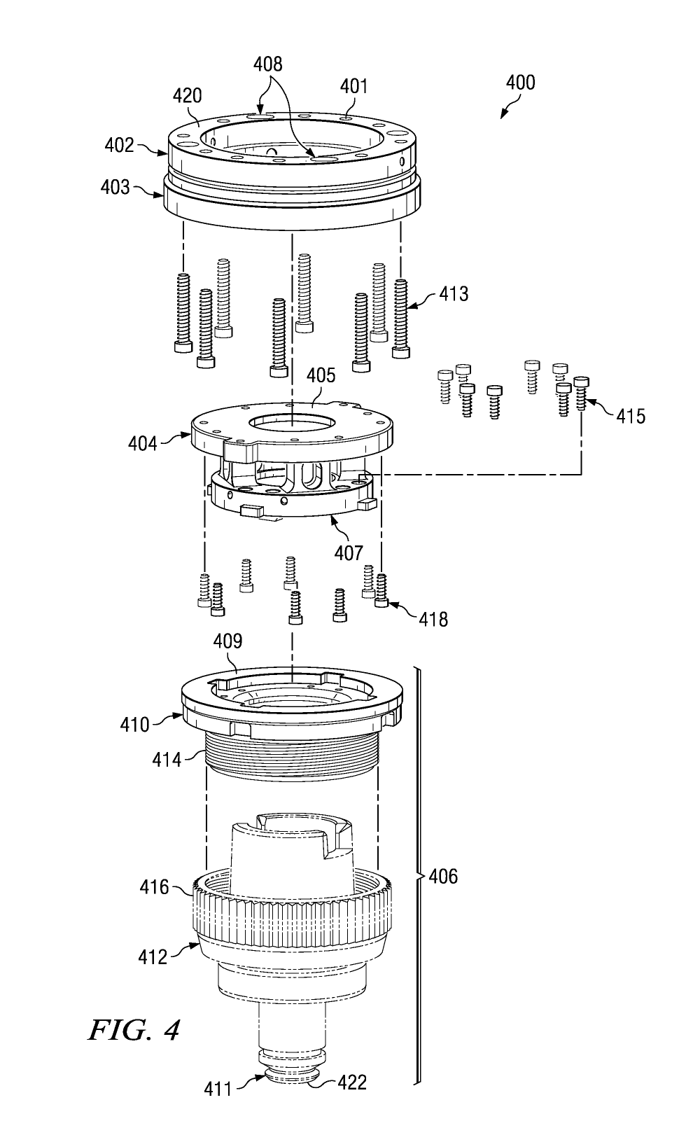

Turning now to FIG. 4, a diagram illustrating an exploded view of an adapter is depicted in accordance with an advantageous embodiment. In this illustrative example, adapter 400 is an example of one implementation for adapter 310 used in manufacturing environment 300 in FIG. 3. Adapter 400 includes machine module 402, instrument module 404, and tool module 406. Machine module 402 has power tool interface 401 and instrument module interface 403. Instrument module 404 has machine module interface 405 and tool module interface 407, and tool module 406 has instrument module interface 409 and tool interface 411.

In this depicted example, machine module 402 includes cooling system 408, which may receive coolant to cool adapter 400 during operation. Instrument module 404 holds sensors for use in sensing and/or monitoring operating conditions during use of adapter 400.

In this illustrative example, tool module 406 has two parts. Tool module 406 has tool holder component 410 and tool holder 412. Tool holder 412 has tool interface 411 that holds the tool and may be connected to tool holder component 410 in tool module 406. In this example, tool holder component 410 has threads 414, which may engage threads 416 on tool holder 412. These threads may be part of instrument module interface 409. Tool holder 412 is used to hold a tool for performing a manufacturing operation. Tool holder 412 may be a collet.

In these depicted examples, fasteners 413, fasteners 415, and fasteners 418 may be used to help in connecting machine module 402, instrument module 404, and tool module 406 to each other for adapter 400. For example, instrument module interface 403 may be connected to machine module interface 405, and tool module interface 407 may be connected to instrument module interface 409.

End 420 on machine module 402 can be configured to be connected to a spindle of a power tool. End 422 of tool module 406 may receive a tool.

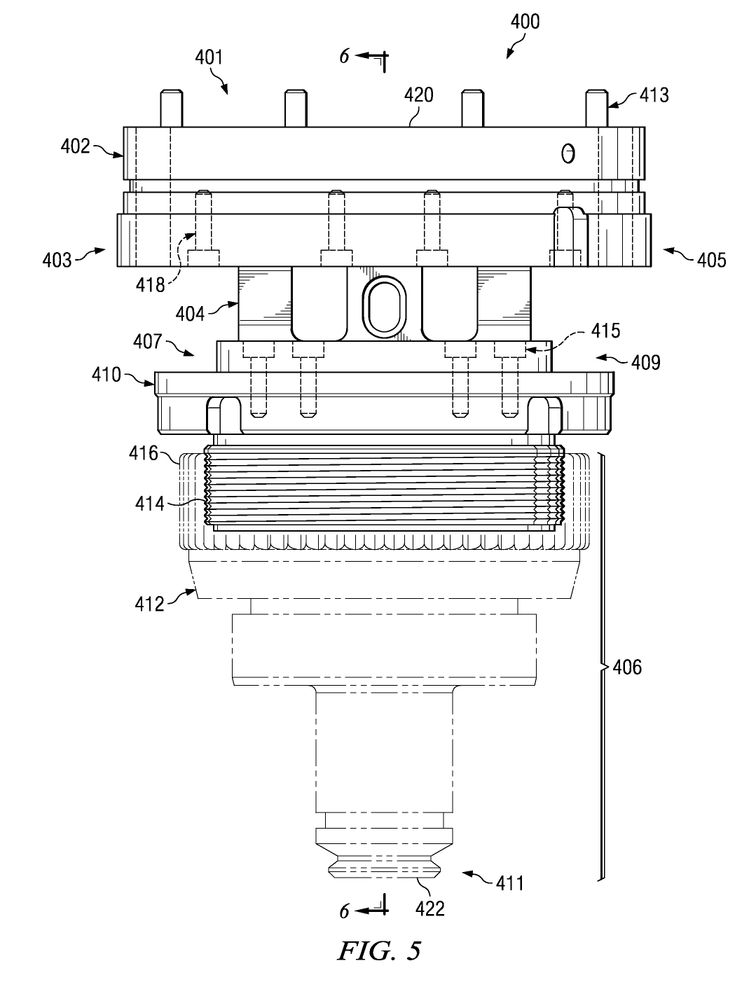

Turning now to FIG. 5, an illustration of a side view of an adapter is depicted in accordance with an advantageous embodiment. In this illustrative example, portions of machine module 402, instrument module 404, and tool module 406 for adapter 400 are shown in phantom.

Fasteners 415 connect tool module 406 to instrument module 404. Fasteners 418 connect instrument module 404 to machine module 402. Fasteners 413 connect machine module 402 to a spindle of a power tool in these examples.

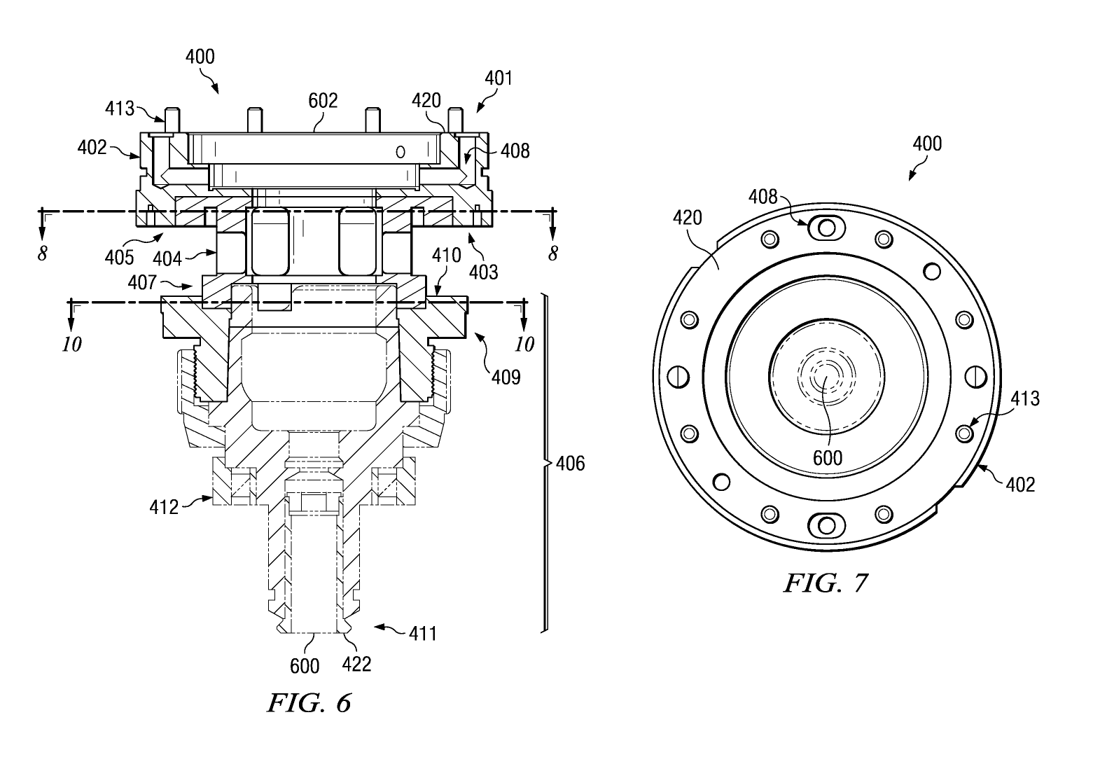

Turning now to FIG. 6, a diagram illustrating a cross-sectional view of an adapter is depicted in accordance with an advantageous embodiment. In this example, adapter 400 is illustrated in a cross-sectional view taken along lines 6-6 in FIG. 5. In this illustrative example, channel 600 is present and extends around axis 602. Channel 600 may receive another spindle and tool. In some advantageous embodiments, channel 600 may not be needed.

In FIG. 7, a view of one end of an adapter is depicted in accordance with an advantageous embodiment. In this illustrative example, end 420 of adapter 400 is shown.

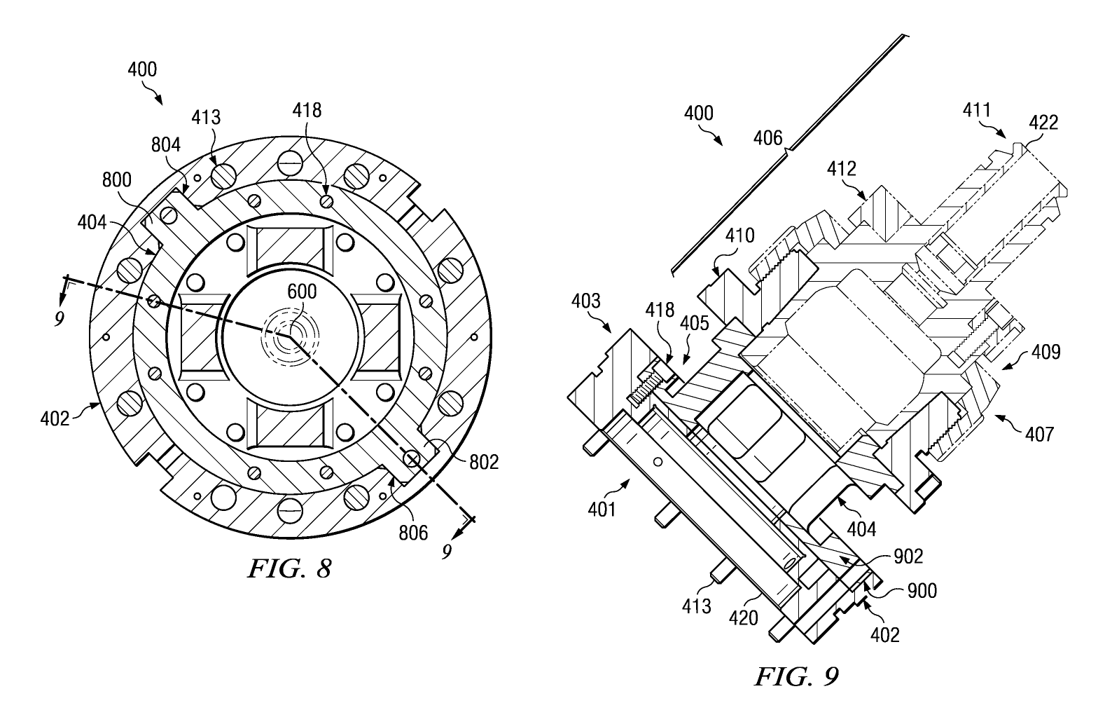

With reference next to FIG. 8, a diagram illustrating a cross-sectional view of an adapter is depicted in accordance with an advantageous embodiment. In this example, adapter 400 is shown in a cross-sectional view taken along lines 8-8 in FIG. 6. In this example, tabs 800 and 802 extend from instrument module 404 and engage slots 804 and 806 in machine module 402. Tabs 800 and 802, when engaged with slots 804 and 806, provide an additional mechanism for holding instrument module 404 in place with respect to machine module 402. Tabs 800 and 802 in slots 804 and 806 may provide a capability to resist moving relative to each other when torque is applied to adapter 400, while performing operations.

Turning now to FIG. 9, a diagram illustrating a cross-sectional view of an adapter is depicted in accordance with an advantageous embodiment. In this example, adapter 400 is seen in a cross-sectional view taken along lines 9-9 in FIG. 8. In this example, slot 900 in machine module 402 is shown engaged with tab 902 for instrument module 404. Slot 900 and tab 902 may provide an additional mechanism to connect machine module 402 to instrument module 404. In these illustrative examples, fasteners 418 are used in conjunction with slot 900 and tab 902. Of course, additional tabs and slots are present but not seen in this particular view.

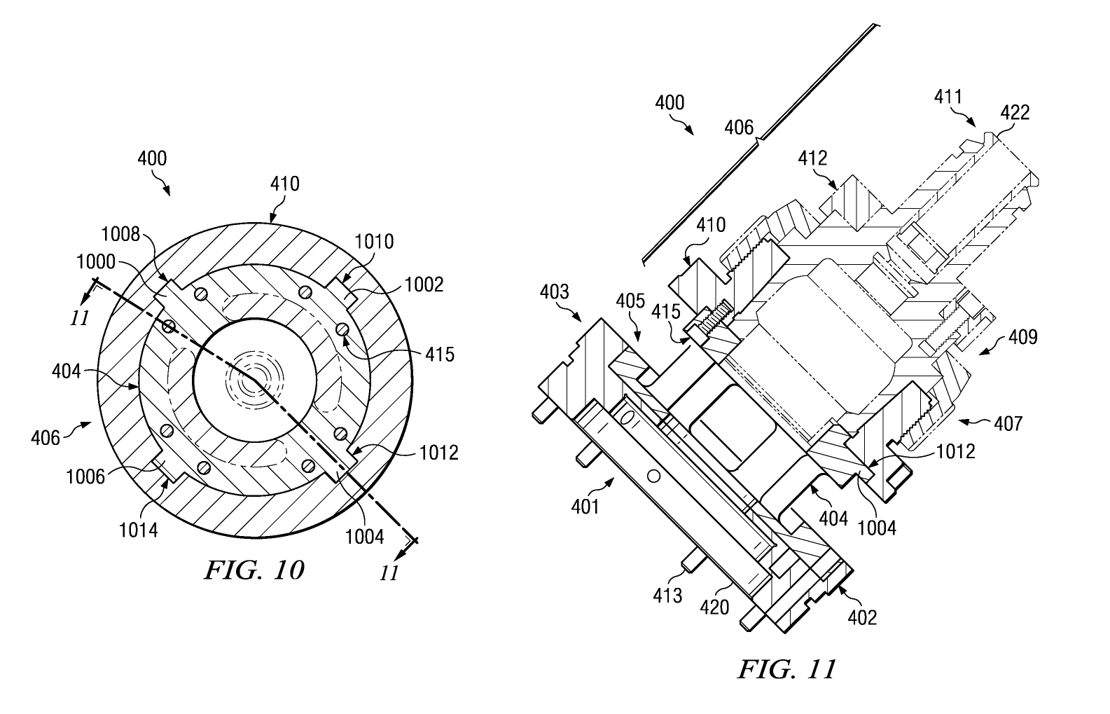

Turning now to FIG. 10, a diagram of a cross-sectional view of an adapter is depicted in accordance with an advantageous embodiment. In this illustrative example, adapter 400 is seen in a cross section taken along lines 10-10 in FIG. 6. In this illustrative example, instrument module 404 has tabs 1000, 1002, 1004, and 1006, which engage slots 1008, 1010, 1012, and 1014, present in tool module end piece 410. The engagement of these tabs with these slots may provide an additional capability to hold tool module 406 in place with instrument module 404. In particular, these tabs and slots may provide a capability to resist torque that may be applied to adapter 400.

Turning now to FIG. 11, a cross-sectional view of an adapter is depicted in accordance with an advantageous embodiment. In this example, adapter 400 is seen in a cross-sectional view taken along lines 11-11 in FIG. 10.

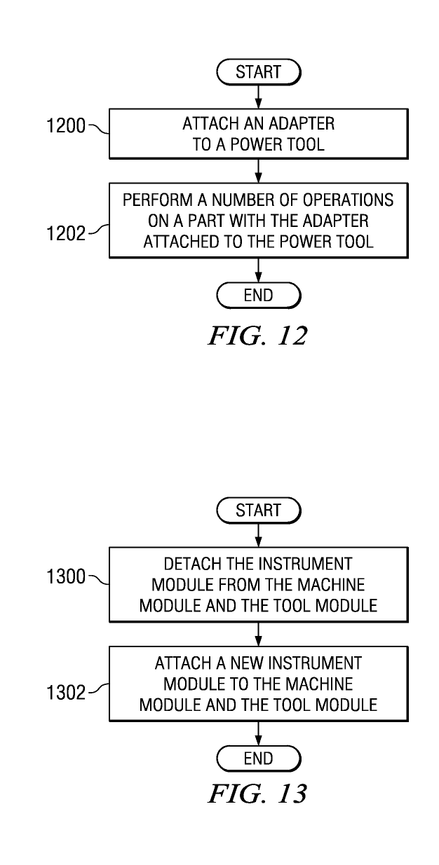

With reference now to FIG. 12, a flowchart of a process for operating a power tool is depicted in accordance with an advantageous embodiment. The process illustrated in FIG. 12 may be implemented using power tool system 302 in manufacturing environment 300 in FIG. 3.

The process begins by attaching an adapter to a power tool (operation 1200). In these examples, the adapter comprises a machine module connected to the power tool, an instrument module connected to the machine module, and a tool module connected to the instrument module. The instrument module is capable of generating signals containing information about operating conditions during operation of the power tool. The instrument module is capable of holding a tool for use in performing operations.

A number of operations are performed on a part with the adapter attached to the power tool (operation 1202), with the process terminating thereafter.

Turning now to FIG. 13, a flowchart of a process for replacing a portion of an adapter is depicted in accordance with an advantageous embodiment. The process illustrated in FIG. 13 may be used to change an instrument module in an adapter, such as adapter 310 in FIG. 3.

The process begins by detaching the instrument module from the machine module and the tool module (operation 1300). The process then attaches a new instrument module to the machine module and the tool module (operation 1302), with the process terminating thereafter. This process may replace an instrument module with a new instrument module without having to remove the machine module from the power tool.

With the operations illustrated in FIG. 13, a loss of coolant and maintenance needed to replace coolant can be avoided if a cooling system is present. Further, resealing the cooling system to the power tool also may be avoided. Additionally, damage to the interfaces connecting the machine module to the power tool also may be avoided by leaving the machine module attached to the power tool.

The flowcharts and block diagrams in the different depicted embodiments illustrate the architecture, functionality, and operation of some possible implementations of apparatus and methods in different advantageous embodiments. In this regard, each block in the flowchart or block diagrams may represent a module, segment, function, and/or a portion of an operation or step.

In some alternative implementations, the function or functions noted in the block may occur out of the order noted in the figures. For example, in some cases, two blocks shown in succession may be executed substantially concurrently, or the blocks may sometimes be executed in the reverse order, depending upon the functionality involved.

Thus, the different advantageous embodiments provide a method and apparatus for operating a power tool. One or more of the different advantageous embodiments may include a machine module capable of being connected to a power tool, an instrument module capable of being connected to the machine module and capable of generating signals containing information about operating conditions during operation of the power tool, and a tool module capable of being connected to the instrument module and capable of holding a tool.

The different advantageous embodiments provide a capability to reduce the amount of maintenance that may be required to operate a power tool with an adapter. Further, the different advantageous embodiments also may provide a capability to reduce the amount of time that a power tool is unavailable. For example, replacing a module for an adapter may take less time than to remove and replace a single piece adaptor from a spindle of a power tool.

The description of the different advantageous embodiments has been presented for purposes of illustration and description, and is not intended to be exhaustive or limited to the embodiments in the form disclosed. Many modifications and variations will be apparent to those of ordinary skill in the art. Although the different illustrative examples have been depicted with respect to performing operations to manufacture an aircraft, the different advantageous embodiments may be applied to other types of platforms.

For example, without limitation, other advantageous embodiments may be applied to a mobile platform, a stationary platform, a land-based structure, an aquatic-based structure, a space-based structure and/or some other suitable object. More specifically, the different advantageous embodiments may be applied to, for example, without limitation, a submarine, a bus, a personnel carrier, a tank, a train, an automobile, a spacecraft, a space station, a satellite, a surface ship, a power plant, a dam, a manufacturing facility, a building and/or some other suitable object.

Further, different advantageous embodiments may provide different advantages as compared to other advantageous embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. A power tool system comprising:
a machine module comprising a housing having a power tool interface capable of being connected to a power tool, a first instrument module interface capable of being connected to an instrument module, and a cooling system;
the instrument module comprising a housing having a machine module interface capable of being connected to the first instrument module interface on the machine module, a tool module interface, and a number of a sensors capable of measuring a number of operating conditions and capable of generating a number of signals;
a tool module comprising a housing having a second instrument module interface capable of being connected to the tool module interface on the instrument module and a tool interface capable of receiving a tool.

2. The power tool system of claim 1, wherein the first instrument module interface has a first number of slots and a first plurality of holes; the machine module interface has a first number of tabs capable of engaging the first number of slots and a second plurality of holes capable of being aligned with the first plurality of holes when the first number of slots is engaged with the first number of tabs to form first aligned holes; the tool interface has a second number of slots and a third plurality of holes; and the second instrument module interface has a second number of tabs capable of engaging the second number of slots and a fourth plurality of holes capable of being aligned with the third plurality of holes when the second number of slots is engaged with the second number of tabs to form second aligned holes, and further comprising:
a first plurality of fasteners capable of being installed in the first aligned holes; and
a second plurality of fasteners capable of being installed in the second aligned holes.

3. The power tool system of claim 1 further comprising:
the power tool.

4. The power tool system of claim 1, wherein the number of signals contains information about the number of operating conditions during operation of the power tool.

5. The power tool system of claim 2, wherein the power tool is selected from one of a friction stir welding machine, a drill, a milling machine, a grinder, a riveting machine, a lathe, and a cutting machine.

6. An apparatus comprising:
a machine module capable of being connected to a power tool; and
an instrument module capable of being connected to the machine module and capable of generating a number of signals containing information about a number of operating conditions during operation of the power tool.

7. The apparatus of claim 6 further comprising:
a tool module capable of being connected to the instrument module and capable of holding a tool.

8. The apparatus of claim 6, wherein the instrument module is capable of receiving a tool.

9. The apparatus of claim 6, wherein the machine module comprises:
a housing having a power tool interface capable of being connected to the power tool and an instrument module interface capable of being connected to the instrument module; and
a cooling system.

10. The apparatus of claim 6, wherein the number of operating conditions comprises at least one of a load, an axial load, a radial load, torque, temperature, and revolutions per minute.

11. The apparatus of claim 6, wherein the instrument module comprises:
a housing having a machine module interface capable of being connected to the machine module and a tool module interface capable of being connected to a tool module; and
a number of sensors capable of measuring the number of operating conditions and capable of generating the number of signals containing the information about the number of operating conditions during the operation of the power tool.

12. The apparatus of claim 11, wherein the number of sensors comprises at least one of an accelerometer, a strain gauge, a piezoelectric sensor, a wheat-stone bridge, a temperature sensor, and a position sensor.

13. The apparatus of claim 6, wherein the machine module has a number of slots and the instrument module has a number of tabs capable of engaging the number of slots in the machine module.

14. The apparatus of claim 13, wherein the machine module has a first plurality of holes and the instrument module has a second plurality of holes, wherein the first plurality of holes is capable of being aligned with the second plurality of holes to form aligned holes when the number of tabs are engaged with the number of slots and further comprising:
a plurality of fasteners capable of being installed in the aligned holes to connect the machine module to the instrument modules.

15. The apparatus of claim 7, wherein the tool module has a number of slots capable of engaging a number of tabs in the instrument module.

16. The apparatus of claim 15, wherein the tool module has a first plurality of holes and the instrument module has a second plurality of holes, wherein the first plurality of holes is capable of being aligned with the second plurality of holes to form aligned holes when the number of tabs are engaged with the number of slots and further comprising:
a plurality of fasteners capable of being installed in the aligned holes to connect the tool module to the instrument module.

17. The apparatus of claim 7, wherein the tool module comprises:
a housing having an instrument module interface capable of being connected to the instrument module and a tool interface capable of receiving the tool.

18. The apparatus of claim 7, wherein the machine module is capable of being connected to a spindle in the power tool.

19. The apparatus of claim 18, wherein the spindle is a first spindle and further comprising:
a channel extending through the machine module, the instrument module, and the tool module, wherein the channel is capable of receiving a second spindle in the power tool, wherein the second spindle is concentric to the first spindle.

20. The apparatus of claim 6, wherein the power tool is selected from one of a drill, a lathe, a milling machine, a friction stir welding machine, a grinder, and a cutting machine.

21. A method for operating a power tool, the method comprising:
attaching an adapter to the power tool, wherein the adapter comprises a machine module connected to the power tool; an instrument module connected to the machine module and capable of generating a number of signals containing information about a number of operating conditions during operation of the power tool; and
performing a number of operations on a part with the adapter attached to the power tool.

22. The method of claim 21, wherein the adapter further comprises a tool module capable of being connected to the instrument module and capable of holding a tool.

23. The method of claim 21, wherein the instrument module is capable of receiving a tool.

24. The method of claim 23 further comprising:
detaching the instrument module from the machine module and the tool module; and
attaching a new instrument module to the machine module and the tool module.

25. The method of claim 23, wherein the number of operations is selected from one of a friction stir welding operation, a drilling operation, a milling operation, a grinding operation, a riveting operation, a lathing operation, and a cutting operation.
